(19) United States
(12) Patent Application Publication
(10) Pub. No.: US 2025/0122050 A1
(43) Pub. Date: Apr. 17, 2025

(54) ELEVATOR TENSION MEMBER ELONGATION AND STIFFNESS MONITORING SYSTEM

(71) Applicant: Otis Elevator Company, Farmington, CT (US)

(72) Inventors: Randall Roberts, Hebron, CT (US); Bardia Guilani, Woodstock Valley, CT (US)

(21) Appl. No.: 18/487,652

(22) Filed: Oct. 16, 2023

(51) Int. Cl. B66B 7/12; B66B 1/06; B66B 1/34; B66B 3/00

(52) U.S. Cl. CPC B66B 7/1238; B66B 1/06; B66B 1/3476; B66B 1/3492; B66B 3/002

(57) ABSTRACT

A monitoring system of an elevator system in which an elevator car and a counterweight, which are attached to a tension member, travel through a hoistway in opposite directions is provided. The monitoring system includes a controller to cause the elevator car to travel to a predefined position in the hoistway, a sensor to sense a position of the counterweight with the elevator car stopped at the predefined position and to generate data corresponding to sensing results and a processor operably coupled to the sensor and configured to analyze the data and to calculate, based on analysis results, an elongation of the tension member.

### BACKGROUND

The present disclosure relates to elevator systems and, in particular, to an elevator tension member elongation and stiffness monitoring system.

In an elevator system, a hoistway is built into a building and an elevator car travels up and down along the hoistway to arrive at landing doors of different floors of the building. The elevator car is attached to a suspension belt at one of the suspension belt. A counterweight is attached to the other end of the suspension below. The movement of the elevator car is driven by a machine that is controlled by a controller according to instructions received from users of the elevator system. When those instructions dictate that the elevator car should move upwardly through the hoistway, the machine rotates in one direction causing the elevator car to move upwardly and the counterweight to move downwardly. Conversely, when the instructions dictate that the elevator car should move downwardly through the hoistway, the machine rotates in an opposite direction causing the elevator car to move downwardly and the counterweight to move upwardly.

### SUMMARY

According to an aspect of the disclosure, a monitoring system of an elevator system in which an elevator car and a counterweight, which are attached to a tension member, travel through a hoistway in opposite directions is provided. The monitoring system includes a controller to cause the elevator car to travel to a predefined position in the hoistway, a sensor to sense a position of the counterweight with the elevator car stopped at the predefined position and to generate data corresponding to sensing results and a processor operably coupled to the sensor and configured to analyze the data and to calculate, based on analysis results, an elongation of the tension member.

In accordance with additional or alternative embodiments, the controller is configured to cause the elevator car to travel to the predefined position in response to an instruction to initiate a tension member monitoring control mode.

In accordance with additional or alternative embodiments, the processor is further configured to estimate tension member life based on the elongation.

In accordance with additional or alternative embodiments, the processor is further configured to shut down the elevator system in an event the tension member life is less than a shutdown limit and the processor is further configured to issue an alarm in an event the tension member life is less than an alarm limit but not less than the shutdown limit.

In accordance with additional or alternative embodiments, at least one of the sensor is mounted on the elevator car with a field-of-view (FOV) encompassing at least a portion of the counterweight with the elevator car stopped at the predefined position and the sensor is mounted remote from the elevator car with a field-of-view (FOV) encompassing at least a portion of the counterweight with the elevator car stopped at the predefined position.

In accordance with additional or alternative embodiments, the sensor is a LiDAR sensor.

In accordance with additional or alternative embodiments, the sensor is a millimeter waver RADAR sensor.

In accordance with additional or alternative embodiments, the sensor is an RGBD camera.

In accordance with additional or alternative embodiments, the sensor is one of a LiDAR sensor, a RADAR sensor or a camera.

According to an aspect of the disclosure, a monitoring method is provided for use with an elevator system in which an elevator car and a counterweight, which are attached to a tension member, travel through a hoistway in opposite directions. The monitoring method includes causing the elevator car to travel to a predefined position in the hoistway, sensing a position of the counterweight with the elevator car stopped at the predefined position, generating data corresponding to results of the sensing, analyzing the data and calculating, based on results of the analyzing, an elongation of the tension member.

In accordance with additional or alternative embodiments, the method further includes receiving an instruction to initiate a tension member monitoring control mode and the causing of the elevator car to travel to the predefined position is responsive to the receiving of the instruction to initiate the tension member monitoring control mode.

In accordance with additional or alternative embodiments, the method further includes estimating tension member life based on the elongation.

In accordance with additional or alternative embodiments, the method further includes shutting down the elevator system in an event the tension member life is less than a shutdown limit and issuing an alarm in an event the tension member life is less than an alarm limit but not less than the shutdown limit.

In accordance with additional or alternative embodiments, at least one of the sensing is executed by a sensor mounted on the elevator car with a field-of-view (FOV) encompassing at least a portion of the counterweight with the elevator car stopped at the predefined position and the sensing is executed by a sensor mounted remote from the elevator car with a field-of-view (FOV) encompassing at least a portion of the counterweight with the elevator car stopped at the predefined position.

According to an aspect of the disclosure, a monitoring method is provided for use with an elevator system in which an elevator car and a counterweight, which are attached to a tension belt routed around a sheave, and which travel through a hoistway in opposite directions. The monitoring method includes recording a baseline weight of the elevator car, recording, at an initial time, a baseline angular position of the sheave with the elevator car at a known position in the hoistway and at the baseline weight, recording, at a later time, a current angular position of the sheave with the elevator car at the known position in the hoistway and at the baseline weight and transforming a difference between the baseline angular position and the current angular position into a stiffness measurement for the tension belt for use in determining tension belt life.

In accordance with additional or alternative embodiments, the stiffness measurement is directly proportional to the difference between the baseline angular position and the current angular position.

In accordance with additional or alternative embodiments, the known position is a sensed position.

In accordance with additional or alternative embodiments, the method further includes measuring a current weight of the elevator car and recording, at the later time, a modified current angular position of the sheave with the elevator car at the known position in the hoistway and at the current weight, and the transforming includes accounting for a difference between the baseline weight and the current weight in calculating the stiffness measurement.

In accordance with additional or alternative embodiments, the method further includes confirming the stiffness measurement using a change in a characteristic sag-and-bounce of the elevator car over time.

In accordance with additional or alternative embodiments, the characteristic sag-and-bounce is established from data generated at multiple instances of the elevator car becoming occupied.

According to an aspect of the disclosure, a monitoring method for an elevator system in which an elevator car and a counterweight are attached to a tension belt routed around a sheave and travel oppositely through a hoistway is provided. The monitoring method includes recording, at an initial time, first data points comprising first and second angular positions of the sheave with the elevator car at a known position in the hoistway and at first and second elevator car weights, respectively, calculating an initial tension belt elasticity from the first data points, recording, at a later time, second data points comprising first and second current angular positions of the sheave with the elevator car at the known position in the hoistway and at first and second current elevator car weights, respectively, calculating a current tension belt elasticity from the second data points and determining tension belt life from a difference between the initial and current tension belt elasticities.

In accordance with additional or alternative embodiments, the calculating of the initial tension belt elasticity from the first data points includes calculating a ratio of a difference between the first and second elevator car weights to a difference between the first and second angular positions and the calculating of the current tension belt elasticity from the second data points includes calculating a ratio of a difference between the first and second current elevator car weights to a difference between the first and second current angular positions.

In accordance with additional or alternative embodiments, the known position is a sensed position.

In accordance with additional or alternative embodiments, the second elevator car weight is a sum of the first elevator car weight and an additional weight and the second current elevator car weight is a sum of the first current elevator car weight and an additional weight.

In accordance with additional or alternative embodiments, the additional weight includes at least one of passenger and load weights sensed by a load weighing sensor.

In accordance with additional or alternative embodiments, the additional weight is determined from a motor torque change.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an elevator system in accordance with embodiments;

FIG. 2 is a side view of an elevator car with a sensor in accordance with embodiments;

FIG. 3 is a side view of an elevator car with a remote sensor in accordance with embodiments;

FIG. 4 is a schematic diagram of a processor in accordance with embodiments;

FIGS. 5A and 5B are graphical diagrams illustrating point cloud data generated by a sensor in accordance with embodiments;

FIG. 6 is a flow diagram illustrating a monitoring method for use with an elevator system in accordance with embodiments;

FIG. 7 is a graphical diagram illustrating an operation of a stiffness-based monitoring method in accordance with embodiments;

FIG. 8 is a flow diagram illustrating a stiffness-based monitoring method for use with an elevator system in accordance with embodiments;

FIG. 9 is a flow diagram illustrating a monitoring method for use with an elevator system in accordance with embodiments; and

FIG. 10 is a flow diagram illustrating a monitoring method for use with an elevator system in accordance with embodiments.

### DETAILED DESCRIPTION

In the elevator industry, suspension members, including coated steel belts (CSBs), need to be monitored for various characteristics including, but not limited to, their remaining load carrying capability and stiffness. Elevator tension members, in the form of CSBs, can often times use changes in resistance due to mechanical fretting of their cords as a measure of residual life for tension member life predictions. But some cord designs do not exhibit much fretting so a new non-resistance based measure is needed. Furthermore, electrical resistance monitoring of ropes is not always a robust solution due to the obvious grounding of ropes as they interact with various metal components in an elevator system.

CSB test data has, however, shown that suspension belt elongation tracks with suspension belt load carrying capability and thus can fulfill the monitoring requirement. Some concepts have been proposed for this purpose and those typically involve adding sensors and switches in the hoistway or on the counterweight (CWT), requiring time to install the devices and most importantly time and cost to install the required wiring with power and communication.

As will be described below, a sensor, such as a LiDAR sensor, is provided on an elevator car or in a machine room of an elevator system to view the CWT when the elevator car is landed at a position in the hoistway. A 2D LiDAR sensor, for example, is then able to scan across the hoistway to measure the location of the CWT. A change in the relative position of the CWT (i.e., to the elevator car) can be used to monitor tension member elongation over time. That is, as the tension members age and elongate, changes in the relative position of the CWT can be correlated with changes in tension member elongation and used as a determinant of tension member load carrying capability. Preliminary test data indicates a 0.1% elongation is a likely detection threshold, which is well within the resolution capabilities of low cost 2D LiDAR sensor.

In addition, as will be discussed below, a system and method for measuring suspending belt stiffness is provided. The system and method include readings from various components of an elevator system and a processing system for determining tension member stiffness from those various readings.

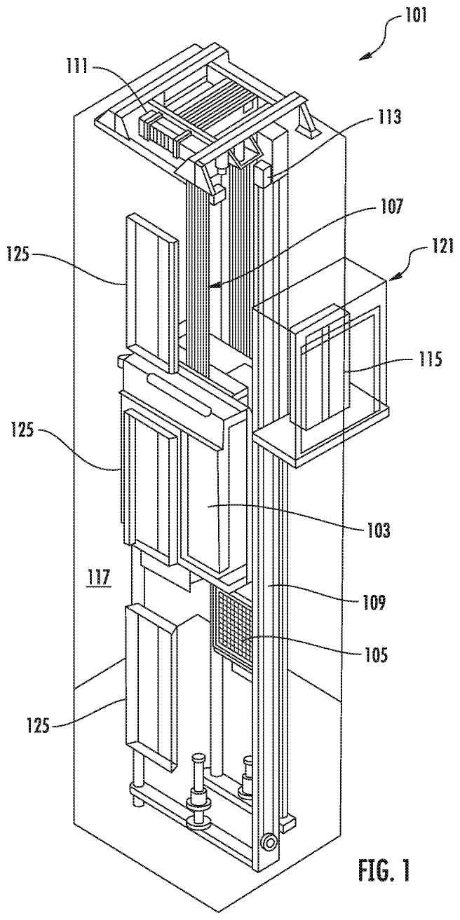

With reference to FIG. 1, which is a perspective view of an elevator system 101, the elevator system 101 includes an elevator car 103, a counterweight 105, a tension member or tension member 107, a guide rail 109, a machine 111, a position reference system 113 and a controller 115. The elevator car 103 and the counterweight 105 are connected to each other by the tension member 107. The tension member 107 may include or be configured as, for example, ropes, coated ropes, steel cables and/or coated-steel belts. The counterweight 105 is configured to balance a load of the elevator car 103 and is configured to facilitate movement of the elevator car 103 concurrently and in an opposite direction with respect to the counterweight 105 within a hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the hoistway 117, such as on a support or guide rail, and may be configured to provide position signals related to a position of the elevator car 103 within the hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the hoistway 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to the tension member 107 to move the elevator car 103 within hoistway 117.

The elevator system 101 also includes one or more elevator doors 104. The elevator door 104 may be integrally attached to the elevator car 103 or the elevator door 104 may be located on a landing 125 of the elevator system 101, or both. Embodiments disclosed herein may be applicable to both an elevator door 104 integrally attached to the elevator car 103 or an elevator door 104 located on a landing 125 of the elevator system 101, or both. The elevator door 104 opens to allow passengers to enter and exit the elevator car 103.

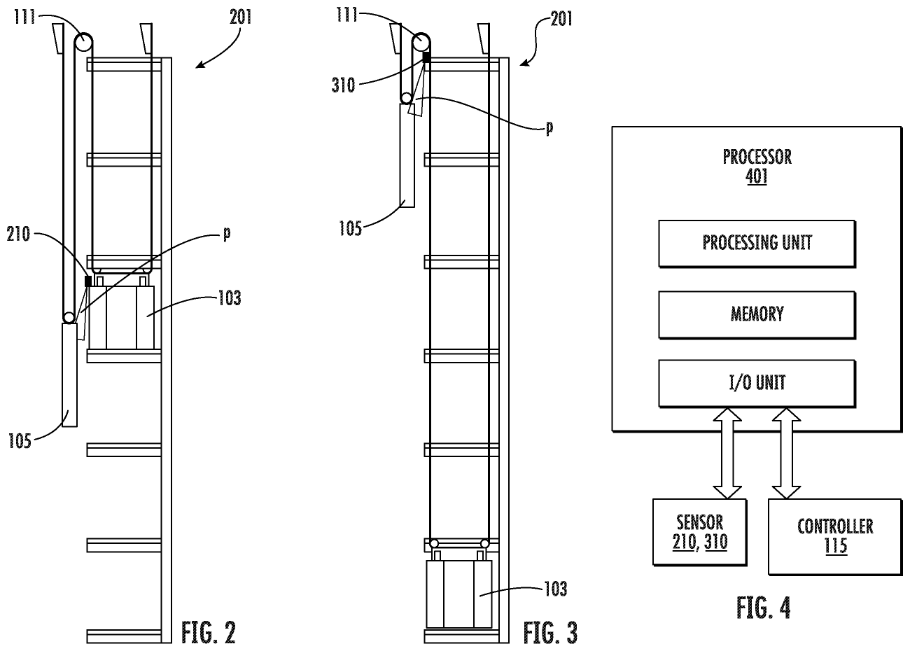

With continued reference to FIG. 1 and with additional reference to FIGS. 2 and 3 and FIG. 4, a monitoring system 201 of an elevator system, such as the elevator system 101 of FIG. 1, is provided. The monitoring system 201 includes a controller, such as the controller 115, which is configured to control the machine 111 to cause the elevator car 103 to travel to a predefined position (i.e., a landing 125 or a mid-hatch position) in the hoistway 117. In this case, the controller 115 can be configured to cause the elevator car 103 to travel to the predefined position in response to an instruction to initiate a tension member monitoring control mode being received by the controller 115. The monitoring system 201 further includes a sensor 210 (see FIG. 2), sensor 310 (see FIG. 3) to sense a position of the counterweight 105 with the elevator car 103 stopped at the predefined position and to generate data corresponding to sensing results and a processor 401. The processor 401 is operably coupled to the sensor 210, 310 and is configured to analyze the data and to calculate, based on analysis results, an elongation of the tension member 107. The processor 401 can be further configured to estimate tension member life based on the elongation of the tension member 107. In addition, the processor 401 can be further configured to shut down the elevator system 101 in an event the tension member life is determined to be less than a shutdown limit. Alternatively, the processor 401 can be further configured to issue an alarm in an event the tension member life is less than an alarm limit but not less than the shutdown limit.

As shown in FIG. 2, the sensor 210 can be mounted on the elevator car 103 in such a way that a field-of-view (FOV) of the sensor 210 encompasses at least a portion of the counterweight 105 with the elevator car 103 stopped at the predefined position. For example, with the elevator car 103 stopped at a landing and with the counterweight 105 being disposed to partially overlap with the elevator car 103 in a height-wise dimension, the sensor 210 can be mounted to a ceiling of the elevator car 103 and aimed downwardly toward the counterweight 105.

Alternatively, as shown in FIG. 3, the sensor 310 can be mounted remote from the elevator car 103 in such a way that the FOV of the sensor 310 encompasses at least a portion of the counterweight 105 with the elevator car 103 stopped at the predefined position. For example, with the elevator car 103 stopped at the elevator pit and with the counterweight 105 being proximate to the ceiling of the hoistway 117, the sensor 310 can be mounted at or near the ceiling of the hoistway 117 and aimed downwardly toward the counterweight 105.

As shown in FIG. 4, the processor 401 includes a processing unit, a memory and an input/output (I/O) unit by which the processor 401 is communicative with the sensor 210, 310 and at least the controller 115 (see FIG. 1). The memory has executable instructions stored thereon, which are readable and executable by the processing unit. When the processing unit reads and executes the executable instructions, the executable instructions cause the processor to operate as described herein. In accordance with embodiments, the executable instructions may include a machine-learning algorithm, which improves certain operations of the processing unit over time. The processor 401 can be remote from the sensor 210, 310 or local. In the former case, the processor 401 can be operably coupled to the sensor 210, 310 via a wired connection or via a wireless connection. In the latter case, the processor 401 can be built into the sensor 210, 310 or provided as a separate component from the sensor 210, 310 and operably coupled to the sensor 210, 310 via a wired connection or via a wireless connection.

In accordance with embodiments, the sensor 210, 310 can include or be provided as one or more of a light detection and ranging or a laser imaging, detection, and ranging (LiDAR) sensor, a radio detection and ranging (RADAR) sensor and/or a camera. In accordance with further embodiments, the sensor 210, 310 can be provided as one or more of a 2D LiDAR sensor, a millimeter wave RADAR sensor and/or a red, green, blue, depth (RGBD) camera. In accordance with still further embodiments, the sensor 210, 310 can be provided as plural sensors including a combination of one or more sensor types listed herein.

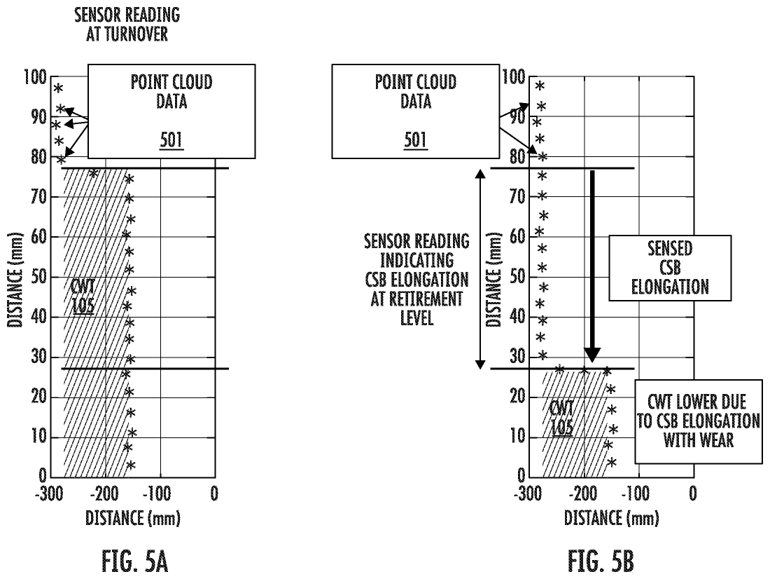

With continued reference to FIGS. 1-4 and with additional reference to FIGS. 5A and 5B, in the exemplary case of the sensor 210, 310 being a 2D LiDAR sensor, the sensor 210, 310 is configured to sense the plane P in each of FIGS. 2 and 3 as a 2D plane. In these or other cases, the sensor 210, 310 is configured to generate the data as point cloud data 501 using a single scan for image processing, multiple scans for image processing and/or multiple successive or continuous scans for video processing and the processor 401 is configured to analyze the point cloud data 501 and to determine whether the point cloud data 501 is indicative of the counterweight 105 being in the plane P as evidenced by the point cloud data 501 of FIG. 5A or being at least partially outside of the plane P as evidenced by the point cloud data 501 of FIG. 5B.

It will be understood that an elongation of the tension member 107 will cause a corresponding sag in the positioning of the counterweight 105. This sag will manifest as a change in relative distances between the elevator car 103 and the counterweight 105 in the embodiments of FIG. 2 and as a change in a distance between the counterweight 105 in the hoistway 117 and a fixed element in the hoistway 117 in the embodiments of FIG. 3. Thus, for the point cloud data 501 of FIG. 5A, the processor 401 can recognize that the counterweight 105 is at a certain position relative to the elevator car 103 or in the hoistway 117 and that this certain position is not evidence of an elongation of the tension member 107 whereas, for the point cloud data 501 of FIG. 5B, the processor 401 can recognize that the counterweight 105 is at a certain position relative to the elevator car 103 or in the hoistway 117 and that this certain position is evidence of an elongation of the tension member 107.

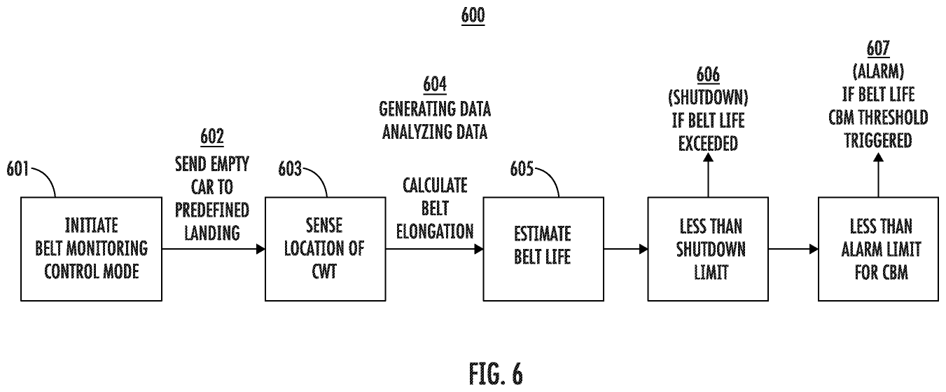

With reference to FIG. 6, a monitoring method 600 is provided for use with an elevator system, such as the elevator system 101 of FIG. 1, and/or the monitoring system 201 of FIGS. 2-5B. As shown in FIG. 6, the monitoring method 600 includes initially receiving an instruction to initiate a tension member monitoring control mode (601), causing the elevator car to travel to a predefined position in the hoistway in response to the instruction being received (602), sensing a position of the counterweight with the elevator car stopped at the predefined position (603) and generating data corresponding to results of the sensing, analyzing the data and calculating, based on results of the analyzing, an elongation of the tension member (604). As described above, the sensing of 603 can be executed by a sensor, such as a 2D LiDAR sensor, that is mounted on an elevator car or remotely from the elevator car. The monitoring method 600 can further include estimating tension member life based on the elongation (605) and either shutting down the elevator system in an event the tension member life is less than a shutdown limit (606) or issuing an alarm in an event the tension member life is less than an alarm limit but not less than the shutdown limit (607).

While the description provided above relates to the use of elongation as a way to determine belt life, the following description will relate to the use of belt stiffness for a similar purpose.

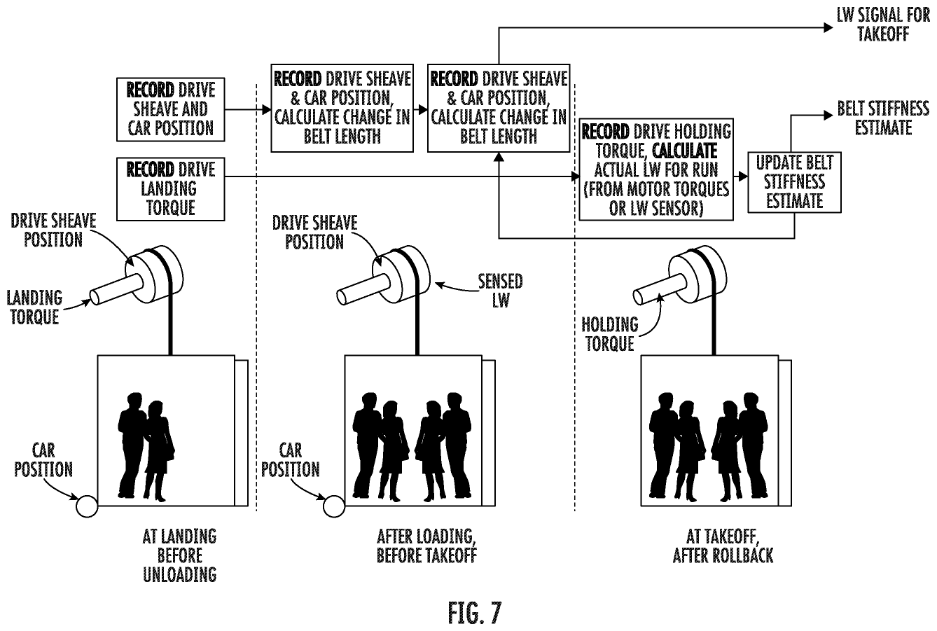

With reference to FIG. 1 and the accompanying text and with additional reference to FIG. 7, an operation of a stiffness-based tension member health monitoring system is illustrated. As shown in FIG. 7, when an elevator car is at a landing and before it is unloaded, an initial drive sheave position and an initial elevator car position can be recorded along with a drive landing torque. After the elevator car is loaded but prior to take-off, a current drive sheave position and current elevator car position can be recorded so that a change in length of the tension member can be measured and an effective stiffness of the tension member can be determined. At take-off of the elevator car, the drive holding torque can be used to calculate an actual load weight of the elevator car and that load weight can then be used to update an estimate of the tension member stiffness.

Thus, it can be seen that there are certain input functional elements (i.e., sensed states) that are needed for the “stiffness-based” tension member health monitoring system. However, it should be noted that the use of the motor torque to estimate a change in a load state could also be done with a specialized sensor termed a “load-weight” sensor which is typically used in elevator systems. This sensed state could be achieved by one or more of the following: (a) platform load weighing that uses under-car load cells to detect the in-car load, (b) tension member tension gauges that sense their tension, such as by a three pronged strain gage approach which we typically use on CSB-equipped elevators and/or (c) termination load cells mounted at the end terminations of 2:1 tension member elevator systems.

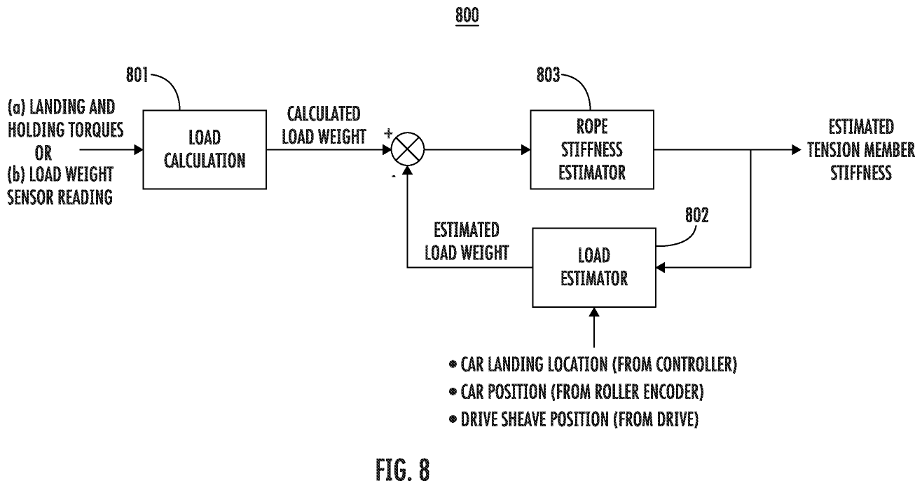

With reference to FIG. 8, a stiffness-based tension member health monitoring method 800 is provided for use with an elevator system, such as the elevator system 101 of FIG. 1 and the stiffness-based tension member health monitoring system of FIG. 7. As shown in FIG. 8, the monitoring method 800 includes calculating a calculated load weight of the elevator car (801), generating, at a load estimator, which is receptive of an estimate of a stiffness of the tension member, an estimated load weight of the elevator car from at least the estimate of the stiffness of the tension member (802) and determining, from a difference between the calculated load weight and the estimated load weight, the estimate of a stiffness of the tension member (803).

In accordance with embodiments, an enabling feature of the “stiffness-based” tension member life monitoring method 800 is the change in load in the elevator at landing and before subsequent take-off is measured (by a direct sensor) or calculated (as shown in this specific embodiment using the change in tension member length from difference of drive sheave position and car position).

In accordance with embodiments, the calculating of the calculated load weight of 801 can be based on landing and holding torques or on a load weight sensor reading. Also, the load estimator can be receptive of the estimate of the stiffness of the tension member and one or more of an elevator car landing location, an elevator car position and a sheave position and, in these or other cases, the load estimator generates the estimated load weight of the elevator car from at least the estimate of the stiffness of the tension member and the one or more of the elevator car landing location, the elevator car position and the sheave position. Notably, the feedback loop in FIG. 8 can be used as part of a learning algorithm to self-calibrate the rope stiffness estimator in a mode that adjusts over time.

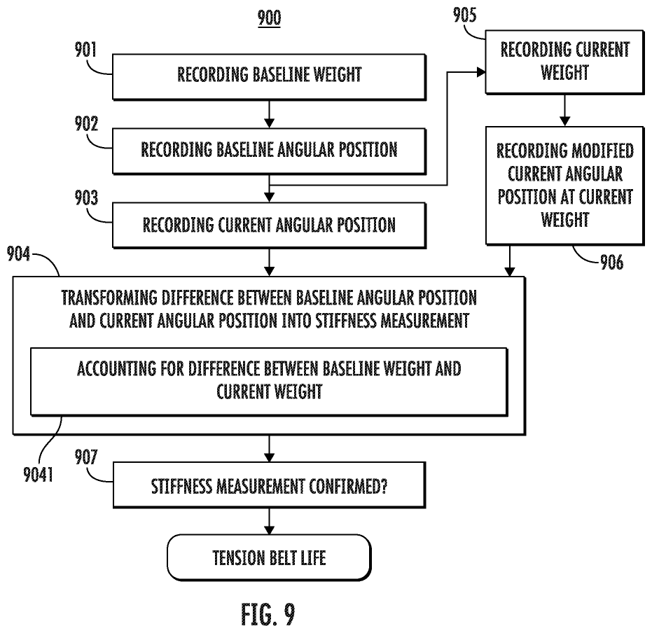

With reference to FIG. 9 and in accordance with further embodiments, a monitoring method 900 is provided for use with an elevator system, such as the elevator system 101 of FIG. 1 and/or the monitoring system 201 of FIGS. 2-5B. As shown in FIG. 9, the monitoring method 900 includes recording a baseline weight of the elevator car (block 901), recording, at an initial time, a baseline angular position of the sheave with the elevator car at a known position in the hoistway and at the baseline weight (block 902), recording, at a later time, a current angular position of the sheave with the elevator car at the known position in the hoistway and at the baseline weight (block 903) and transforming a difference between the baseline angular position and the current angular position into a stiffness measurement for the tension belt for use in determining tension belt life (block 904). The known position of the elevator car can be a sensed position and can be provided by any of the sensors described above. The stiffness measurement can thus be directly proportional to the difference between the baseline angular position and the current angular position (i.e., wherein the difference between the baseline angular position and the current angular position is a percentage of a total angular rotation of the sheave required to move the elevator car from an initial location in the hoistway to the known position).

In accordance with further embodiments, the method 900 can be modified for cases in which a weight of the elevator car is known to change over time. In these or other cases, the method 900 can include measuring a current weight of the elevator car (block 905) and recording, at the later time, a modified current angular position of the sheave with the elevator car at the known position in the hoistway and at the current weight (block 906). Here, the transforming of block 904 can include accounting for a difference between the baseline weight and the current weight in calculating the stiffness measurement (block 9041). In addition, the method can include confirming the stiffness measurement using a change in a characteristic sag-and-bounce of the elevator car over time (block 907), which can be established from data generated at multiple instances of the elevator car becoming occupied (i.e., by a known weight or by people of unknown weights that have to be determined and accounted for in determining the characteristic sag-and-bounce of the elevator car).

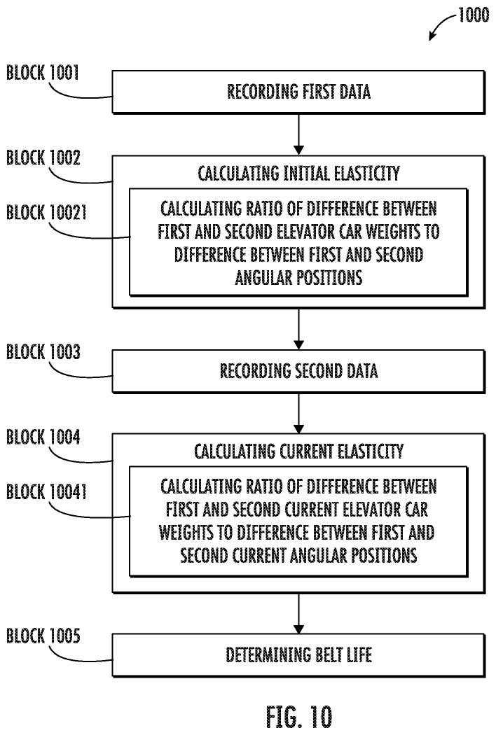

With reference to FIG. 10 and in accordance with further embodiments, a monitoring method 1000 is provided for use with an elevator system, such as the elevator system 101 of FIG. 1 and/or the monitoring system 201 of FIGS. 2-5B. As shown in FIG. 10, the monitoring method 1000 includes recording, at an initial time, first data points comprising first and second angular positions of the sheave with the elevator car at a known position (i.e., a sensed position) in the hoistway and at first and second elevator car weights, respectively (block 1001), calculating an initial tension belt elasticity from the first data points (block 1002), recording, at a later time, second data points comprising first and second current angular positions of the sheave with the elevator car at the known position in the hoistway and at first and second current elevator car weights, respectively (block 1003), calculating a current tension belt elasticity from the second data points (block 1004) and determining tension belt life from a difference between the initial and current tension belt elasticities (block 1005).

In accordance with further embodiments, the calculating of the initial tension belt elasticity from the first data points of block 1002 includes calculating a ratio of a difference between the first and second elevator car weights to a difference between the first and second angular positions (block 10021) and the calculating of the current tension belt elasticity from the second data points of block 1004 includes calculating a ratio of a difference between the first and second current elevator car weights to a difference between the first and second current angular positions (block 10041). In addition, the second elevator car weight can be a sum of the first elevator car weight and an additional weight and the second current elevator car weight can be a sum of the first current elevator car weight and an additional weight. The additional weight can include at least one of passenger and load weights that are sensed by a load weighing sensor or the additional weight can determined from a motor torque change as weights are brought on and off the elevator car.

Technical effects and benefits of the present disclosure are the provision of a low cost sensor, such as a 2D LiDAR sensor, on an elevator car or another part of a hoistway and does not require any additional markers, or switches in the hoistway or powered sensors on the CWT itself. The relatively low-resolution requirements for 0.1% belt elongation are well within the capabilities of LiDAR sensing. The present disclosure thus provides for a monitoring solution that reduces complexity and cost.

Additional technical effects and benefits of the present disclosure are the provision of a system and method for measuring tension member stiffness using readings from various elevator system components. This allows for a determination of belt stiffness using components that are already present in elevator systems and thus presents a cost-effective solution.

It is to be understood that the use of elongation and stiffness described herein to monitor belt health can be used separately or, some cases, jointly to provide for a robust estimate of tension belt life.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A monitoring system of an elevator system in which an elevator car and a counterweight, which are attached to a tension member, travel through a hoistway in opposite directions, the monitoring system comprising:
a controller to cause the elevator car to travel to a predefined position in the hoistway;
a sensor to sense a position of the counterweight with the elevator car stopped at the predefined position and to generate data corresponding to sensing results; and
a processor operably coupled to the sensor and configured to analyze the data and to calculate, based on analysis results, an elongation of the tension member.

2. The monitoring system according to claim 1, wherein the controller is configured to cause the elevator car to travel to the predefined position in response to an instruction to initiate a tension member monitoring control mode.

3. The monitoring system according to claim 1, wherein the processor is further configured to estimate tension member life based on the elongation.

4. The monitoring system according to claim 3, wherein:
the processor is further configured to shut down the elevator system in an event the tension member life is less than a shutdown limit, and
the processor is further configured to issue an alarm in an event the tension member life is less than an alarm limit but not less than the shutdown limit.

5. The monitoring system according to claim 1, wherein at least one of:
the sensor is mounted on the elevator car with a field-of-view (FOV) encompassing at least a portion of the counterweight with the elevator car stopped at the predefined position, and
the sensor is mounted remote from the elevator car with a field-of-view (FOV) encompassing at least a portion of the counterweight with the elevator car stopped at the predefined position.

6. The monitoring system according to claim 1, wherein the sensor is a LiDAR sensor.

7. The monitoring system according to claim 1, wherein the sensor is a millimeter waver RADAR sensor.

8. The monitoring system according to claim 1, wherein the sensor is an RGBD camera.

9. The monitoring system according to claim 1, wherein the sensor is one of a LiDAR sensor, a RADAR sensor or a camera.

10. A monitoring method for use with an elevator system in which an elevator car and a counterweight, which are attached to a tension member, travel through a hoistway in opposite directions, the monitoring method comprising:
causing the elevator car to travel to a predefined position in the hoistway;
sensing a position of the counterweight with the elevator car stopped at the predefined position;
generating data corresponding to results of the sensing;
analyzing the data; and
calculating, based on results of the analyzing, an elongation of the tension member.

11. The method according to claim 10, further comprising receiving an instruction to initiate a tension member monitoring control mode,
wherein the causing of the elevator car to travel to the predefined position is responsive to the receiving of the instruction to initiate the tension member monitoring control mode.

12. The method according to claim 10, further comprising estimating tension member life based on the elongation.

13. The method according to claim 12, further comprising:
shutting down the elevator system in an event the tension member life is less than a shutdown limit; and
issuing an alarm in an event the tension member life is less than an alarm limit but not less than the shutdown limit.

14. The method according to claim 10, wherein at least one of:
the sensing is executed by a sensor mounted on the elevator car with a field-of-view (FOV) encompassing at least a portion of the counterweight with the elevator car stopped at the predefined position, and
the sensing is executed by a sensor mounted remote from the elevator car with a field-of-view (FOV) encompassing at least a portion of the counterweight with the elevator car stopped at the predefined position.

15. A monitoring method for an elevator system in which an elevator car and a counterweight are attached to a tension belt routed around a sheave and travel oppositely through a hoistway, the monitoring method comprising:
recording, at an initial time, first data points comprising first and second angular positions of the sheave with the elevator car at a known position in the hoistway and at first and second elevator car weights, respectively;
calculating an initial tension belt elasticity from the first data points;
recording, at a later time, second data points comprising first and second current angular positions of the sheave with the elevator car at the known position in the hoistway and at first and second current elevator car weights, respectively;
calculating a current tension belt elasticity from the second data points; and
determining tension belt life from a difference between the initial and current tension belt elasticities.

16. The monitoring method according to claim 15, wherein:
the calculating of the initial tension belt elasticity from the first data points comprises calculating a ratio of a difference between the first and second elevator car weights to a difference between the first and second angular positions, and
the calculating of the current tension belt elasticity from the second data points comprises calculating a ratio of a difference between the first and second current elevator car weights to a difference between the first and second current angular positions.

17. The monitoring method according to claim 15, wherein the known position is a sensed position.

18. The monitoring method according to claim 15, wherein:
the second elevator car weight is a sum of the first elevator car weight and an additional weight, and
the second current elevator car weight is a sum of the first current elevator car weight and an additional weight.

19. The monitoring method according to claim 18, wherein the additional weight comprises at least one of passenger and load weights sensed by a load weighing sensor.

20. The monitoring method according to claim 18, wherein the additional weight is determined from a motor torque change.
